(19) United States
(12) Patent Application Publication
(10) Pub. No.: US 2026/0291262 A1
(43) Pub. Date: Sep. 24, 2026

(54) SMART ADAPTIVE BATTERY CHARGER

(71) Applicant: QUALCOMM Incorporated, San Diego, CA (US)

(72) Inventors: Siva Prakash NETTI, Visakhapatnam (IN); Ravi Krishna Chaitanya VEDALA, Hyderabad (IN); Mohana Chandran K, Coimbatore (IN)

(21) Appl. No.: 19/088,700

(22) Filed: Mar. 24, 2025

(51) Int. Cl. H02J 7/00; H02J 50/10

(52) U.S. Cl. CPC H02J 7/485; H02J 7/44; H02J 7/933; H02J 50/10

(57) ABSTRACT

A smart adaptive battery charger is described. The smart adaptive battery charger includes a charging interface coupled to a power sink, where the power sink includes a battery to be charged. The battery charger further includes a supply interface coupled to a power supply configured to provide power to the charging interface, a radio interface coupled to a control device configured to a receive one or more commands from the control device, and a controller coupled to the radio interface and configured to receive the commands from the radio interface. The controller is further coupled to the charging interface and configured to adjust the power provided to the power sink.

### TECHNICAL FIELD

The present application relates generally to a battery charger and more specifically to a battery charger that adapts to different power sinks using smart technology.

### BACKGROUND

Rechargeable devices, such as telephones, tablets, computers, computer peripherals, cameras, speakers, media players, displays, navigation systems, backup batteries, lamps, and more may each require a battery charger. The battery charger (the source) has a plug to receive power, typically mains power or a larger battery, and a plug or inductive coils to provide power to the device (the power sink) at a particular voltage and current. Different devices require different voltages and different currents and different plugs.

Standards have been developed for common physical connectors, e.g., Universal Serial Bus (USB), Lightning, barrel connectors, Qi wireless charging, etc. in order to allow a single battery charger to be connected to different devices and different types of devices. In some cases, standards, e.g., USB Type-C have been developed for physical connectors.

### BRIEF SUMMARY

The following presents a summary of one or more implementations in order to provide a basic understanding of such implementations. The invention is defined by the independent claims. More particular examples are set out in the dependent claims. Examples and aspects that do not fall within the scope of the claims are merely examples used for explanation of the invention. This summary is not an extensive overview of all contemplated implementations and is intended to neither identify key or critical elements of all implementations nor delineate the scope of any or all implementations. Its sole purpose is to present some concepts of one or more implementations in a simplified form as a prelude to the more detailed description that is presented later.

A smart adaptive battery charger is described. In one example, the battery charger includes a charging interface coupled to a power sink. The power sink includes a battery to be charged. A supply interface is coupled to a power supply and configured to provide power to the charging interface. A radio interface is coupled to a control device configured to receive one or more commands from the control device and a controller is coupled to the radio interface and configured to receive the commands from the radio interface. The controller is further coupled to the charging interface and configured to adjust the power provided to the power sink in response to the commands.

In another example, a method includes receiving one or more commands at a battery charger from a control device through a radio interface and adjusting a power provided to a power sink through a charging interface from a supply interface in response to the commands, the power sink comprising a battery to be charged.

In another example, a method includes receiving an identification at a control device of a power sink having a battery to be charged, retrieving a profile for the power sink based on the identification, and sending commands based on the profile to a battery charger through a radio interface of the battery charger to adjust the power provided from the battery charger to the power sink.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the described implementations are intended to include all such aspects and their equivalents.

### BRIEF DESCRIPTION OF THE DRAWINGS

FIG. 1 is a block diagram illustrating an example of a system for charging power sinks by a source using a control device according to aspects of the present disclosure.

FIG. 2 is a more detailed block diagram of an example of a battery charger according to aspects of the present disclosure.

FIG. 3 is a diagram of a touchscreen Graphical User Interface (GUI) for a device selection page of a control device to control the battery charger according to aspects of the present disclosure.

FIG. 4 is a diagram of a touchscreen GUI for a profile selection page of a control device to control the battery charger according to aspects of the present disclosure.

FIG. 5 is a diagram of a touchscreen GUI for a profile edit page of a control device to control the battery charger according to aspects of the present disclosure.

FIG. 6 is a process flow diagram of operating a battery charger to charge a battery of a power sink according to aspects of the present disclosure.

FIG. 7 is a process flow diagram of operating a battery charger in a night charging mode according to aspects of the present disclosure.

FIG. 8 is a process flow diagram of operating a battery charger in a bleed prevention mode according to aspects of the present disclosure.

FIG. 9 is a process flow diagram of a process of charging a power sink at a battery charger according to aspects of the present disclosure.

FIG. 10 is a process flow diagram of controlling the charging of a power sink with a battery charger according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, these concepts may be practiced without these specific details. In some instances, well-known structures and components are shown in block diagram form in order to avoid obscuring such concepts.

The promise of a universal battery charger, whether wired or inductive, is limited by the great variety of different devices with different kinds of batteries. Some devices, e.g., a wireless keyboard, consume little power and can operate for weeks with a small battery on a single charge, while other devices, e.g. a notebook computer, may operate for only a few hours with a much larger battery. In some cases, there are also premium, high speed battery chargers and low-cost slow battery chargers designed to charge the same device. Third party battery chargers are also offered in a variety of different specifications to charge a device. The variety of battery charger connectors and the variety of charging protocols may be significant and so battery chargers have accumulated wherever rechargeable devices are used at home or business. This contributes to electronic waste (e-waste). Many places have various battery chargers, including those that are no longer in use or compatible with newer devices. Growing e-waste has significant environmental impacts.

When a device is charged with a battery charger other than those provided or recommended by the manufacturer, the battery charger can undercharge or overcharge the device's batteries or both. This reduces the device's battery life. Over time, the battery is weakened and its total power capacity is reduced until it must be replaced. Replacing the battery sooner increases more e-waste. In some cases, a mismatched battery charger can set a battery on fire. In other cases, the mismatched battery charger may take many times longer to reach a full charge.

Quick Charging, fast-charging, or rapid charging introduces another risk of universal battery chargers. Quick Charging, including QC 2.0, and QC 3.0 is a feature that requires the battery charger to provide higher power to the batteries to charge them more quickly. However, not all devices support quick charging. In addition, some battery chargers only support quick charging. This creates a possible mismatch between the battery charger and device. In addition, all quick charging reduces the life of the batteries. Quick charging is risky because it requires more precise control of the voltage and current that is provided from the battery charger to the device during a charging cycle because the battery is being charged at a rate near its physical limits. In many circumstances, the manufacturer supports quick charging and does not support a safer slower charging protocol.

USB Type-C is an example of a universal physical charging connector for portable devices including smart phones, computers, cameras, peripherals, speakers, and many other devices. To allow different devices with different sizes and types of batteries to be charged by a single charger, a standard for USB Type-C battery chargers includes Power Delivery (PD) battery charger negotiation. This includes a process that allows a battery charger to send Power Delivery Objects (PDOs) which are available voltage and current combinations, to the device. The device may then select one of the PDOs by returning a Request Data Object (RDO) to the battery charger. This negotiation helps ensure that devices charge quickly and efficiently without overheating or damaging the battery. In PD battery charger negotiation, the battery charger starts in a 5V mode at a medium power and then when the device is able, the battery charger negotiates with the device through configuration channel (CC) wire lines of the USB Type-C connector to determine the voltage and current combination for the device.

A smart adaptive battery charger is described herein that provides a radio interface to a control device. The control device may send commands through the radio interface to the battery charger to set a charging protocol for each device that may be attached to the common charging connector. The radio interface, e.g., Bluetooth, Near Field Communication (NFC), Wi-Fi, etc. may offer two-way communication between the control device and the battery charger. With, for example, an application (App) on the control device, multiple profiles can be set for many different devices to allow the smart adaptive battery charger to use different charging protocols with the same device. The charging protocols may be optimized for each device and based on user input.

As an example, a smart phone may support charging at 120 W. This is a high-power mode that quickly returns the battery to full power. When more time is available, the user may select a profile that delivers 50 W instead of 120 W. While this requires more time to fully recharge the battery, the battery lifetime is improved. The desired profile may be selected by the user on the App of the control device, or the control device may select a suitable profile using particular parameters, e.g. time of day.

Each profile in the control device App may be configured for different devices and for different charging protocols. The charging protocols include the voltage and current to be supplied by the battery charger for the device and selected profile. Once a profile is selected, the control device sends these parameters to the smart battery charger. The battery charger adjusts the output to the device accordingly. This allows a user to improve battery life cycle and health.

One profile for a device may be for quick charging. Another profile may be for a “Night Charging” mode. This mode may provide lower power and then cut off the battery charger output after the device has reached full charge. This prevents “over-charging” that also ruins the phone battery. Another profile may provide for an automatic charge maintenance mode or battery bleed prevention mode in which the constant draining in the phone's battery is counteracted or prevented by detecting a reduced battery voltage and then charging the battery.

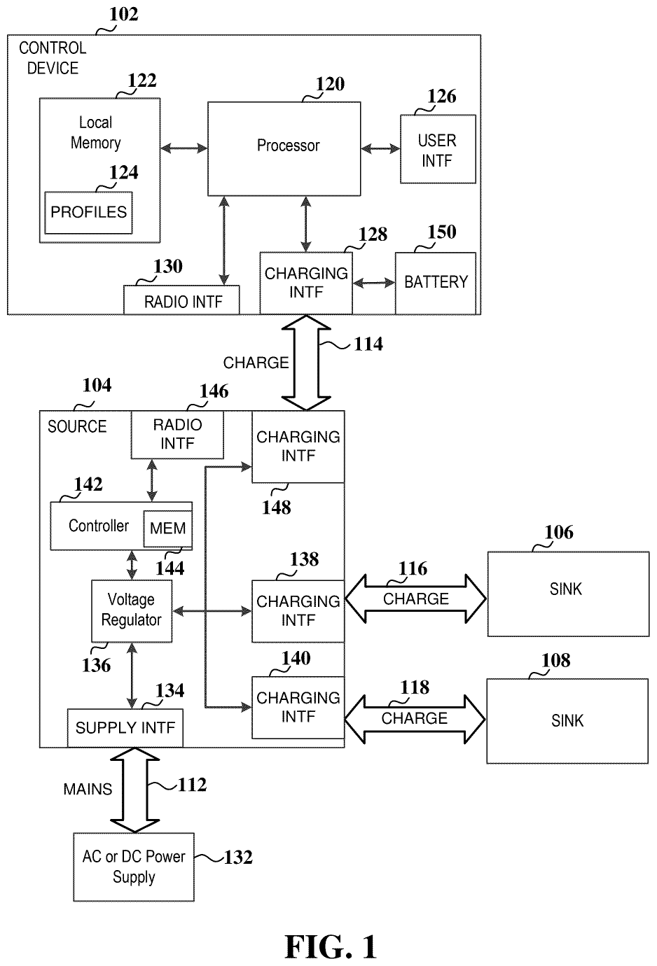

FIG. 1 is a diagram illustrating an example of a system for charging power sinks by a source using a control device. In the example shown in FIG. 1, a battery charger 104 is a source configured to charge one or more power sinks 150, 106, 108 using charging protocols determined by a control device 102. The source is coupled to Alternating Current (AC) power, e.g. main current, or Direct Current (DC) power, e.g. a battery from an AC or DC power supply 132 that is coupled through a power cable 112 to a supply interface 134 of the battery charger 104. Power from the supply interface 134 is provided to a voltage regulator 136 configured to regulate the power provided to any one or more of the power sinks through the respective charging interface. The voltage regulator 136 may be used to regulate the provided voltage and current. The voltage regulator 136 is coupled to one or more charging interfaces 138, 140, 148.

A first charging interface 138 may be coupled to a first power sink 106 through a first charging connection 116, e.g., a charging cable or data cable, to provide power to a battery of the first power sink 106. The wired connection may use a USB connector, a barrel connector, a Thunderbolt connector or any other suitable connector. As a wired connection the wire interface is configured to provide power through at least a portion of the wires. The wire interface may also be configured to receive an identification of the power sink from the power sink through the wire interface. A second charging interface 140 may be coupled to a second power sink 108 through a second charging connection 118, e.g. an inductive coil or wireless charging connection, such as Qi or MagSafe, to provide power to a battery of the second power sink 108. A third charging interface 148 may be coupled through a third charging connection 114 to a charging interface 128 of the control device 102 which acts as a third power sink 150, e.g. the battery of the control device 102.

The battery charger 104 further includes a controller 142 with a local memory 144 which may be integrated with the controller as e.g. a system on a chip or system in a package or it may be a discrete memory. The memory includes programming instructions and charging instructions. The controller 142 is coupled to the voltage regulator 136 to optionally determine voltages and current of the charging interfaces 138, 140, 148 and to control the voltages and current that are provided through the voltage regulator 136. The controller 142 is further coupled to a radio interface 146 of the battery charger to receive commands from the control device 102 through a radio interface 130 of the control device that provides a radio connection between the radio interface 146 of the battery charger and the radio interface 130 of the control device. The controller 142 adjusts the power provided to the power sinks through the voltage regulator 136 in response to the commands. The commands may be in the form of a voltage and current or an identifier of a particular charging protocol in the local memory 144 of the controller 142.

The control device 102 may be in the form of a smart phone, tablet, notebook or desktop computer, home or office automated control system panel, or another device. In some examples, an app may be installed on the device to provide the described functionality. In some examples, the functionality may be integrated into the control device. The control device 102 has a processor 120 to run software and apps. The processor 120 is coupled to local memory 122 which may be integrated with the processor 120, or formed on a separate die or package. The local memory 122 may include profiles 124 for different power sinks.

The control device 102 may have a radio interface 130 with the battery charger 104, e.g., Bluetooth, NFC, Wi-Fi, etc. The control device also includes a user interface 126. In an example, the control device 102 receives a device identifier from the battery charger 104 through the radio interface 130. The processor 120 identifies a profile in the local memory 122 for the device and then sends commands to the battery charger 104 to charge the device. The device identifier may alternatively be provided by a user through the user interface 126. If the control device 102 is the power sink, then the device identifier may come from a register in the control device 102. In another example, the control device 102 provides a device identification through the charging interface 148 of the battery charger 104. A USB charging connection is able to provide data through the USB interface. The device identification is then provided by the controller 142 of the battery charger 104 through the radio interface 146 of the battery charger to the control device.

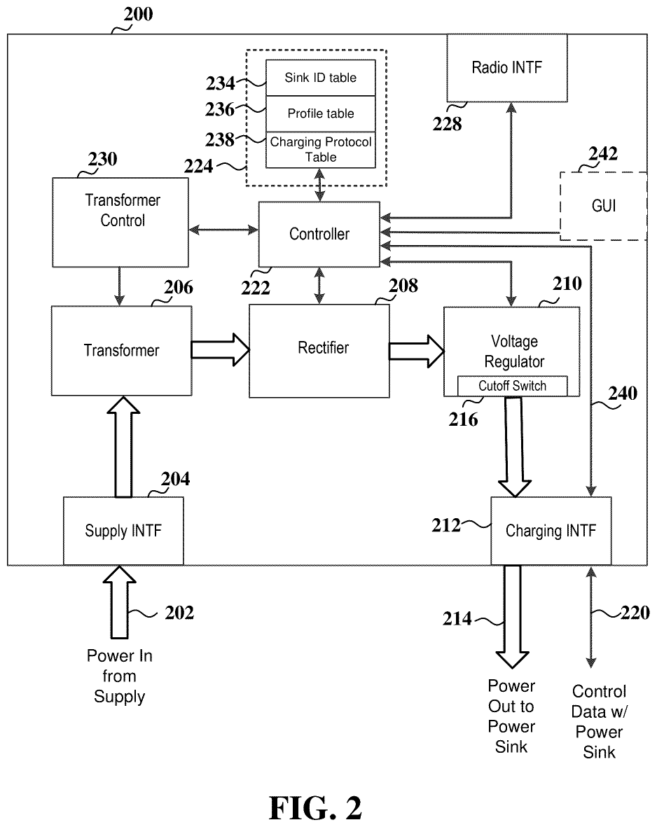

FIG. 2 is a more detailed block diagram of an example of a battery charger according to some aspects. The battery charger 200 is shown as having one external power input through a power cable 202 to a supply interface 204. While this may be mains power, the power in from the supply may be battery power from a different battery that is charged in a separate process. The power from the supply interface 204 is provided at one voltage to a transformer 206, which provides power at a different voltage to a rectifier 208. In some examples, the rectifier 208 converts AC power from the transformer to DC power. The rectifier may provide additional filtering and other functions. The rectifier provides DC current to a voltage regulator 210 which regulates voltage and current of the input power and provides the power to a charging interface 212. The charging interface 212 is coupled to a power sink through a charging connection 214 which may be a wired or magnetic charging connection.

The charging interface 212 also has a control data connection 220 to the power sink. In some examples, the control data connection 220 facilitates the identification protocol of the USB to send an identification from the power sink to the battery charger 200. While this may be performed through the charging interface 212, it may also be performed through another connector or through a radio interface, e.g. NFC, Bluetooth, etc. The identification may have different names and different amounts of detail about the device, but is referred to herein as a device ID. The device ID may include, for example, a model type, a model number, a serial number and/or other information, e.g. International Mobile Equipment Identity (IMEI), Internet Protocol (IP) Address, etc. The identification may also include battery status information that may be used by the battery charger 200 to adjust the power supplied to the power sink. This information is passed to a controller 222 through a power sink data line 240.

The controller 222 is coupled to a transformer control 230 to send commands to the transformer control 230. The transformer control 230 adjusts characteristics of the transformer to control the output voltage of the transformer using e.g. switches, motors, etc. The controller is coupled to the voltage regulator 210 to send commands to the voltage regulator 210. The voltage regulator may adjust voltage and current of the power supplied to the sink device through the charging interface 212. The transformer control 230, the voltage regulator 210, or the charging interface 212 may also include a cutoff switch 216 to turn power to the charging interface 212 off or on. The cutoff switch 216 may be integrated another component or may be a discrete component that is controlled by the controller in response to the charging protocol or in response to battery measurements at the voltage regulator. In some aspects, the controller receives battery status from the power sink through the control data connection 220 and operates the cutoff switch in response to the received battery status.

The controller 222 is further coupled to the charging interface 212 to receive data from and send data to the power sink. The controller is also coupled to a radio interface 228 of the battery charger 200 to receive commands, profiles, device IDs, charging protocols, etc., from a control device. In some examples, the radio interface 228 provides a communication with the power sink. In some examples, the radio interface 228 allows a control device to be used to control charging protocols used for a variety of other devices. The controller is optionally coupled to a graphical user interface 242 which may include buttons, lights, switches, a touchscreen, display and/or other elements. In one example, all operations of the battery charger may be controlled by a control device through the radio interface. In another example, the GUI may be used for some or all of the operations described herein either as a complement to or replacement for the radio interface.

The controller is further coupled to a memory 224 which may be integrated with the controller 222 or discrete from the controller 222. The memory 224 has a sink ID table 234 to store device IDs for one or more different power sinks. The memory further has a profile table 236 to store profiles associated with the device IDs in the sink ID table 234. In addition, the memory may include a charging protocol table 238 to store charging protocols associated with the profiles in the profile table 236. As explained in more detail below, the battery charger may receive a device ID from the charging interface 212, the radio interface 228, or the GUI 242. The device ID is applied to the sink ID table 234 to obtain a profile from the profile table 236. The profile indicates different charging profiles that may be used with the device, e.g., quick charge, gentle charge, night time, etc. A profile may be selected from the profile table 236 using the radio interface 228. The profile is applied to the charging protocol table 238 to determine a suitable charging protocol to be used. The charging protocol may have a voltage and a current and other values. The controller 222 then issues one or more commands to the transformer control 230, the voltage regulator 210 and/or other components to provide the voltage and current that is appropriate for the selected profile.

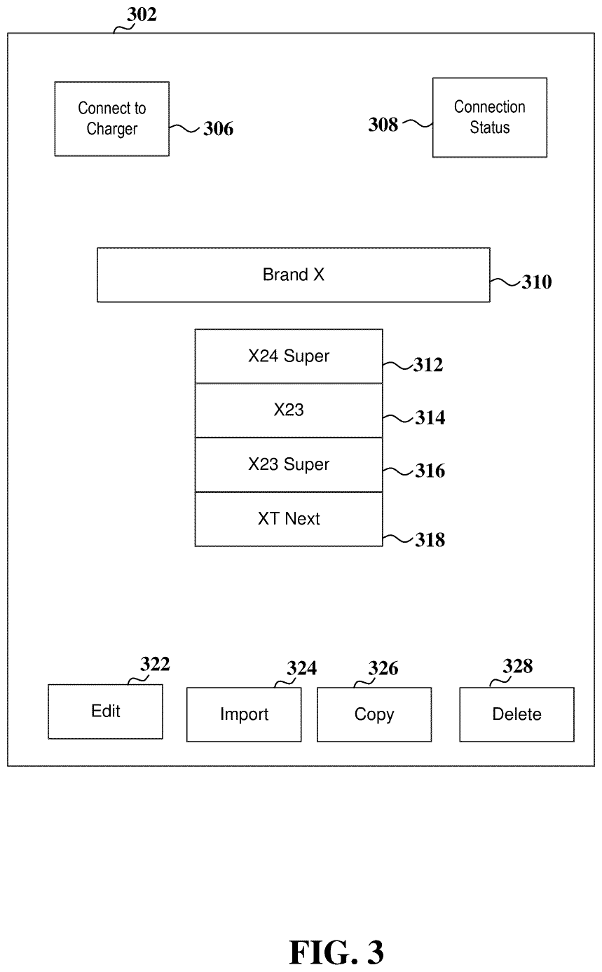

FIG. 3 is a diagram of a touchscreen GUI for a device selection page of a control device to control the battery charger. The control device 102 of FIG. 1 or any other suitable device may be used. The GUI 302 is shown as a touchscreen display, however, other types of display and input may be used including buttons, pen, pointing device etc. The particular arrangement and appearance of the display features may be modified to suit other types of control devices.

On this page of the GUI 302, a device is selected using a hierarchical classification system. A user has selected Brand X as displayed in a primary pane 310. “Brand X” represents any particular brand or make of interest for use of the battery charger. Alternatively, the control device or the battery charger may have been able to determine that the power sink is of “Brand X” but is unable to precisely determine the model. The GUI 302 presents four selection buttons 312, 314, 316, 318 to select one of the four types or models under the classification displayed in the primary pane 310. The example models shown are labeled as X24 Super, X23, X23 Super, and XT Next. Each of these selection buttons corresponds to a different model device under the category of Brand X. More or fewer selection buttons may be used to suit different configurations. In one example, the control device has a profile for each of these device models stored in its memory. The profiles may be stored in an initial or default configuration or added by a user. The models for each selection button may be based on entries provided by a user, an original manufacturer configuration, or information collected over time through the radio interface in use.

The GUI 302 further includes touchscreen areas for an edit button 322 to open a GUI page to edit a model. An import button 324 opens a GUI page to import a model for the same or another category as shown in the primary pane 310. A copy button 326 creates a copy of the current model or a copy of another model. A delete button 328 deletes the current model or category. A connect to charger button 306, when touched, issues a command to the control device to establish a radio connection through respective radio interfaces to establish a radio connection with the battery charger. A connection status button 308 is configured to open a page to show and modify the status of the connection between the battery charger and the control device. The edit, import, and copy buttons may be used to add power sinks to the control device memory that are not already configured. A power sink that is not preconfigured in an App or for which no online profile is available to the control device may be configured for the battery charger using the various options on the GUI 302.

Through the GUI 302, the power sink that is connected to the battery charger may be identified as being one of the models as indicated by an appropriate selection of one of the selection buttons 312, 314, 316, 318. In some examples, the model is determined by the control panel though communication with the battery charger. For example, the battery charger obtains the model information, e.g., as a device ID, through a radio interface or charging interface of the battery charger.

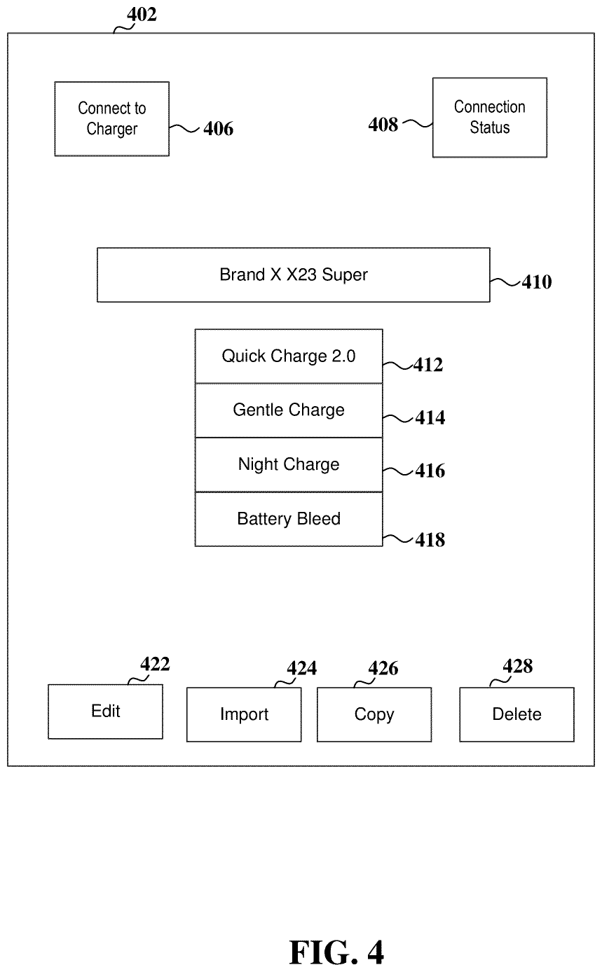

FIG. 4 is a diagram of a touchscreen GUI for a profile selection page of a control device to control the battery charger. The control device 102 of FIG. 1 or any other suitable device may be used. The GUI 402 is shown as a touchscreen display, however, other types of display and input may be used including buttons, pen, pointing device etc. The particular arrangement and appearance of the display features may be modified to suit other types of control devices. The profile selection page may be displayed after receiving a selection from one of the selection buttons of FIG. 3 or it may be rendered after the control device receives a device ID from the battery charger. The control device may apply the received device ID to a sink ID table or a similar structure to build the profile selection of the GUI 402.

On this page of the GUI 402, a model is shown in a primary pane 410 as Brand X X23 Super which is also one of the selections presented in the model selection GUI 302. The GUI 402 presents four selection buttons 412, 414, 416, 418 to select one of four profiles under the model displayed in the primary pane 410. The examples shown are labeled as Quick Charge 2.0, Gentle Charge, Night Charge, and Battery Bleed. Each of these selection buttons corresponds to a different voltage and current combination to provide to charge the power sink, which is identified as a Brand X X23 Super. More or fewer selection buttons may be used to suit different configurations. These profiles are described in more detail below. In one example, the control device has a profile for each of these devices stored in its memory. A user may edit, import, copy, or delete any of these profiles using the further buttons shown below the four selection buttons 412, 414, 416, 418 shown. In some examples, a user can select one of the four profiles. The control panel is configured to send the selected profile through a radio interface to the battery charger. The battery charger can then charge the power sink using the selected profile.

The GUI 402 further includes an edit button 422 to open a GUI page to edit a profile. An import button 424 opens a GUI page to import a profile for the same or another device. A copy button 426 creates a copy of the current profile or another profile. A delete button 428 deletes the current profile or category. A connect to charger button 406, when touched, issues a command to the control device to establish a radio connection through respective radio interfaces to establish a radio connection with the battery charger. A connection status button 408 opens a page to show and modify the status of the connection between the battery charger and the control device.

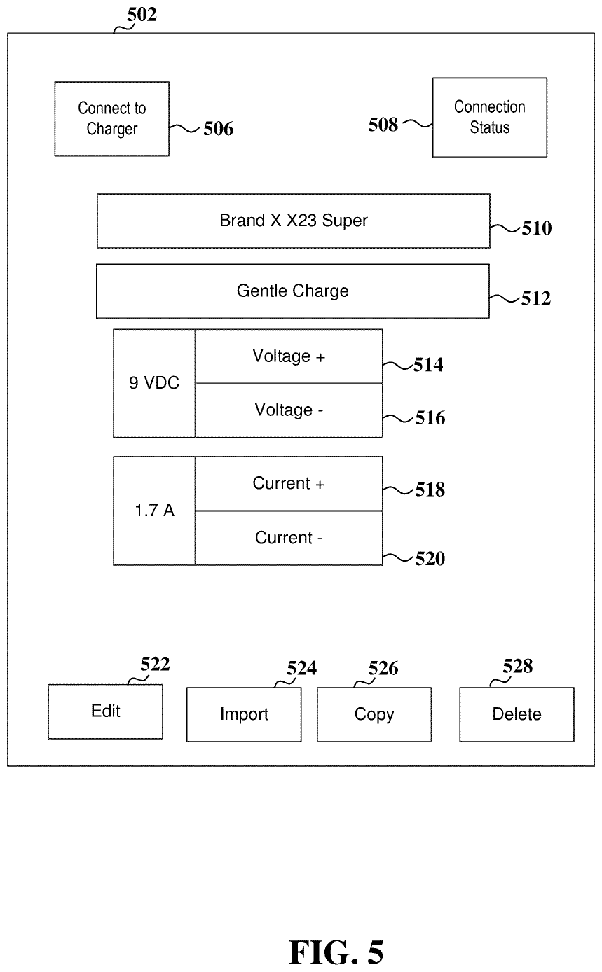

FIG. 5 is a diagram of a touchscreen GUI for a profile edit page of a control device to control the battery charger. In one example, the edit page presents a user with predetermined options that limit the possible configurations for any particular profile. In one example, profiles cannot be edited and only preprogrammed profiles may be selected.

On the profile edit page of the GUI 502, a model is shown in a primary pane 510 as Brand X X23 Super which is also one of the selections presented in the model selection GUI 302. The selected profile is shown in a secondary pane 512 as Gentle Charge. The GUI 502 presents four selection buttons 514, 516, 518, 520. The first and second selection buttons 514, 516 allow the voltage, set to 9 VDC, to be adjusted up or down. The third and fourth selection buttons 518, 520 allow the current, set to 1.7A, to be adjusted up or down. The control device may be configured with limits to prevent the settings from exceeding the capabilities of the power sink. More or fewer selection buttons may be used to suit different configurations. Additional options may be presented to allow a user to change other parameters of a profile.

The GUI 502 further includes an edit button 522 to open a GUI page to edit a profile. An import button 524 opens a GUI page to import a profile for the same or another device. A copy button 526 creates a copy of the current profile or another profile. A delete button 528 deletes the current profile or category. A connect to charger button 506, when touched, issues a command to the control device to establish a radio connection through respective radio interfaces to establish a radio connection with the battery charger. A connection status button 508 opens a page to show and modify the status of the connection between the battery charger and the control device.

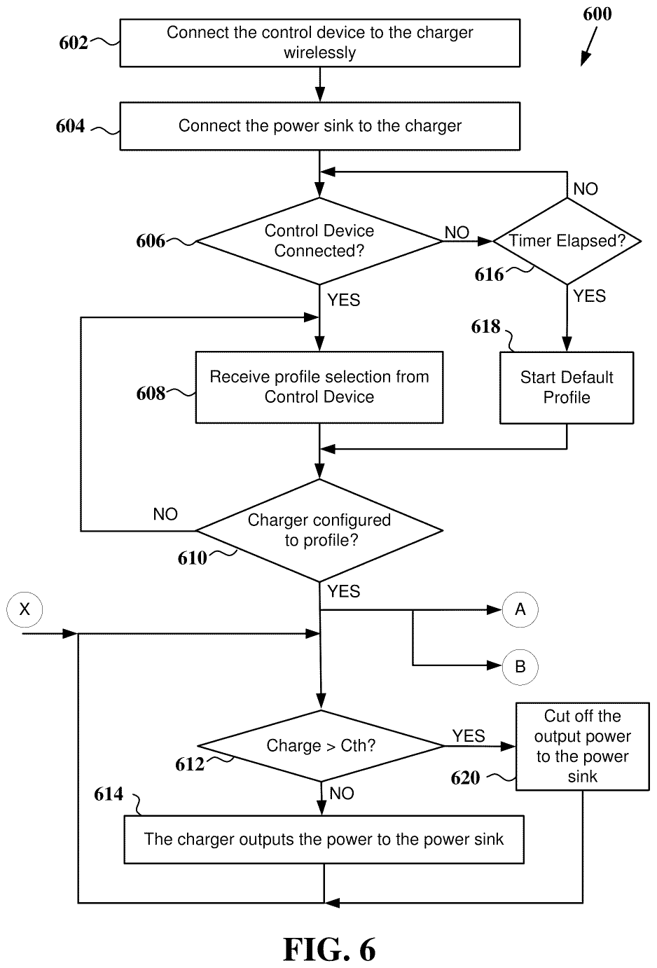

FIG. 6 is a process flow diagram of operating a smart adaptive battery charger to charge a battery of a power sink. At 602, a control device is connected to the charger wirelessly via Bluetooth or any other suitable radio interface. At 604, the power sink is connected to the battery charger through USB or any other suitable power connection, including, for example, inductive chargers, e.g. Qi. At decision block 606, the battery charger determines whether the control device is connected. If the control device is connected, then the process continues at 608 to receive a profile selection from the control device.

At 608, if the control device is connected, a profile is received at 608 from the control device for the connected power sink. The profile may include a voltage and a current or there may be more parameters for the profile. The profile may be selected by receiving a device ID from the power sink. For example, the device ID may be provided to the control device through Bluetooth and then the profile may be received from the control device based on the device ID, using e.g. a look up table at the control device. In some examples, a user can select a profile on the control device using a GUI as described above with respect to FIGS. 3 to 5.

In some examples, the control device and the power sink are the same device. An App or utility of the device may offer a selection of charging protocols when it determines that it has been connected to the battery charger. In some examples, the control device is able to provide profiles to the battery charger for power sinks that do not support an App or do not have an installed App. At decision block 610, the battery charger determines whether the battery charger is configured to the profile received at 608. This may include setting a voltage and current level for the power sink.

If the battery charger determines at decision block 610 that the charger has not been configured to a profile, then the process returns to operation 608 to receive a profile for the connected power sink. This operation may include receiving a device ID and then selecting a profile or a profile from among a plurality of different profiles that have been configured for the received device ID.

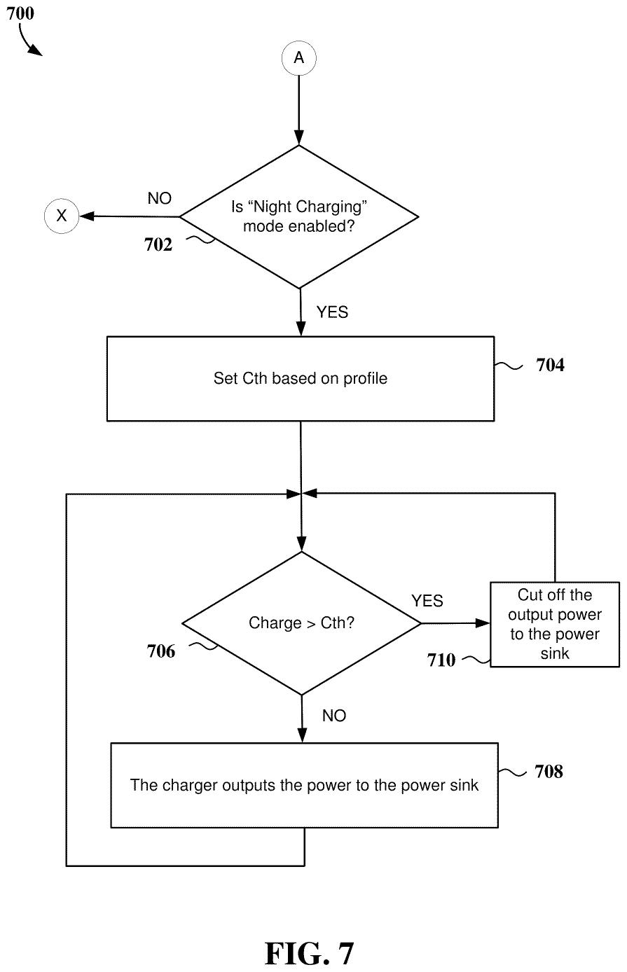

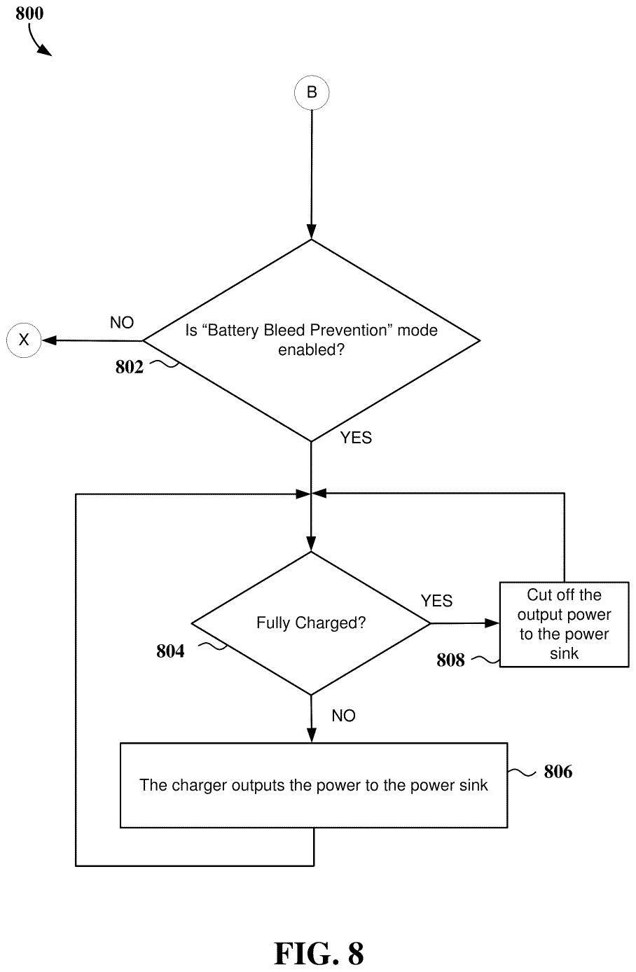

At decision block 610, if the battery charger has been configured to the profile, then the process proceeds to a charging cycle. Different charging profiles may cause the process to branch to a different charging cycle. A first charging profile goes to decision block 612. In some examples, the process goes to branch “A” of FIG. 7 based on a night charging mode profile. In other examples, the process goes to a branch “B” of FIG. 8 based on a battery bleed prevention profile. There may be additional charging profiles for the power sink as may be configured by a user or preconfigured in a particular installation or example implementation. If the battery charger has not been successfully configured at decision block 610, then the process returns to 608 to receive a profile selection from the control device and perform the configuration again. The charger may send a request for a profile or a fail message to the control device through the wireless connection.

If, at decision block 610, the battery charger is configured to the profile, then at decision block 612, the battery charger determines whether the battery is charged up to a charging threshold Cth. If yes, then at 620, the battery charger cuts off the output power to the power sink and the charging cycle ends. The battery charger may determine the charge on the battery by receiving charge level data from the power sink or by measuring conditions at the power connection between the charging interface of the charger and the power sink.

The charging threshold may be a part of the charging profile. In some examples, a plurality of different charging thresholds may be allowed for the same device. The different charging thresholds may be selected by a user, including in corresponding different charging profiles, or provided in different default configurations for a single device. A device may have a maximum charging threshold to allow the device to operate for longer before recharging. The device may also have reduced charging thresholds to extend the battery's life over multiple charging cycles. A device or charging profiles for the device may allow for a charging threshold at full charge and also for a battery saver charging threshold at e.g., 80% or another fraction of the full charge. Preconfigured charging profiles or a profile edit page of a control device may be used to allow a user to select between different charging thresholds, Cth.

If, at decision block 612, the battery is not charged to the charging threshold, then, at 614, the charger outputs power to the power sink via USB or other charging connection established at 602. The parameters of the power, e.g., voltage and current, are determined by the particular profile that was received at 608 and configured at decision block 610. The process returns to decision block 612 to determine again if the battery is completely charged.

Returning to decision block 606, it may happen that the control device cannot be successfully connected to the charger. If so, then the process goes to a timer at 616. At 616, the battery charger determines whether the timer has elapsed. If it has not elapsed, then the process continues to wait by returning at decision block 606 to determine if the control device is connected. If the timer has elapsed at 616, then a default profile may be started at 618. The default profile may be to apply a medium level of voltage and current that is able to operate different devices without damage. The process then goes to decision block 610 to determine whether the battery charger is configured to a default profile. If the battery is configured to a start profile at decision block 610, then the process then goes to a charging cycle suitable for the default profile e.g. at decision block 612. In some instances, the control device is not available or out of range and cannot be connected. The charger then operates in a conventional mode with a default profile. In other circumstances, the power sink may require recharging before it can communicate a connection or a device ID. In other circumstances, the control device is also the power sink and requires a charge before it can operate its wireless interface to connect to the charger. After the power sink, or control device, or both are charged to an initial operational state, then the control device may be able to connect at decision block 606 and send a profile to the battery charger to complete the charging cycle.

FIG. 7 is a process flow diagram of charging a battery using a smart adaptive battery charger in a night charging mode. At decision block 702, the battery charger determines if night charging mode is enabled. The decision block at decision block 702 is from the decision block 610 of FIG. 6 when it is determined that the charger is configured for a profile. If, at decision block 702, the night charging mode is not enabled, then the process returns at branch “X” to the decision block at decision block 612 of FIG. 6 to determine if the battery charge exceeds the charge threshold Cth at decision block 612 of the charging profile determined at 608 as shown in FIG. 6. If night charging is enabled at decision block 702, then at 704, the charging threshold Cth is set based on the value included in the respective night charging profile or by selection from the control device. The charging threshold may be full charge or some lesser charge level to reduce stress on the battery.

The battery charger then operates a charging cycle. This includes determining if the battery charge exceeds the charging threshold at decision block 706. If the charge exceeds the charging threshold at decision block 706, then the battery charger cuts off the output power to the power sink, e.g. using the cutoff switch, at 710. The process returns to check the battery charge at decision block 706 so that the battery charge is maintained. If the battery charge does not exceed the charging threshold, then at 708, the battery charger outputs power to the power sink and then returns to decision block 706 to determine if the battery power exceeds the charging threshold.

FIG. 8 is a process flow diagram of operating a battery charger in a battery bleed prevention mode. At decision block 802, the battery charger determines if battery bleed prevention mode is enabled. The decision block at decision block 802 is from the decision block 610 of FIG. 6 when it is determined that the charger is configured for a profile. If, at decision block 802 the battery bleed prevention mode is not enabled, then the process returns at branch “X” to the decision block at 612 of FIG. 6 to determine if the battery charge exceeds the charge threshold Cth at decision block 612 of the charging profile determined at 608 as shown in FIG. 6.

If battery bleed prevention is enabled at decision block 802, then the battery charger operates a charging cycle. This includes determining if the battery is fully charged at decision block 804. If the battery of the power sink if fully charged then the battery charger cuts off the output power to the power sink, e.g. using the cutoff switch, at 808. The process returns to check the battery charge, at decision block 804, so that the battery charge is maintained. If the battery is not fully charged at decision block 804, then at 806, the battery charger outputs power to the power sink and then returns to decision block 804 to determine if the battery power exceeds the charging threshold.

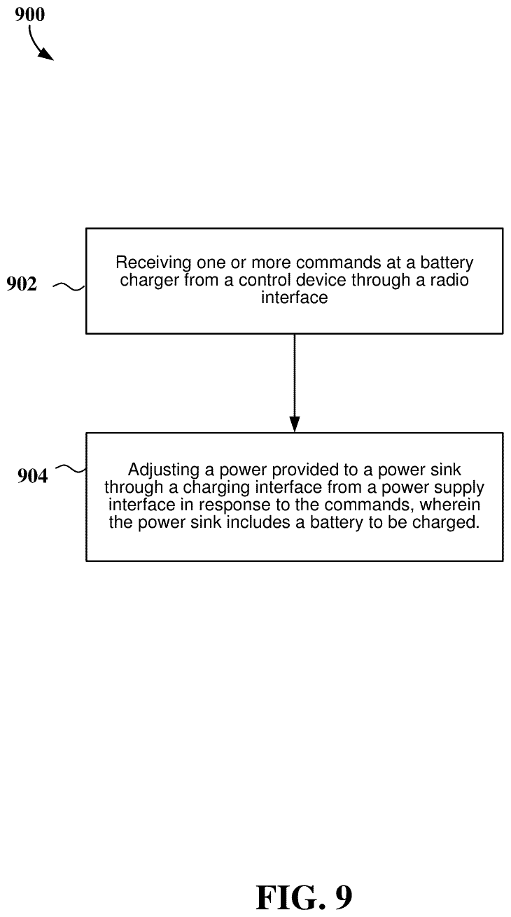

FIG. 9 is a process flow diagram of a process 900 of charging a power sink at a battery charger. At 902, the process begins with receiving one or more commands at a battery charger from a control device through a radio interface. In examples, the control device first receives an identification of a power sink, the device to be charged. The control device sends the one or more commands in response to receiving the identification. In examples, the control device receives the identification through a GUI. In examples, an identification of the power sink is received from the power sink, e.g., through a Bluetooth radio or a charging interface, at the battery charger. The battery charger sends the identification to the control device through the radio interface. In examples, the power sink sends the identification to the control device through its own radio interface. In examples, the control device and the power sink are the same device so that the control device knows the identification.

The commands may be a particular voltage and current, a charging protocol, a profile identifier or another form of command. In examples, receiving the one or more commands includes receiving a profile identifier of a charging profile. The charging profile defines a charging protocol for the power sink. In examples, the battery charger applies the profile identifier to a local memory of the battery charger to determine the charging profile for the power sink.

At 904, the process continues with adjusting the power provided to a power sink through a charging interface from a power supply interface in response to the commands, wherein the power sink includes a battery to be charged. In examples, adjusting the power includes regulating a voltage provided to the power sink through the charging interface by a voltage regulator. In examples, the voltage regulator is coupled to a controller. The controller receives the one or more commands, retrieves a charging protocol, and regulates the voltage in response to the charging protocol.

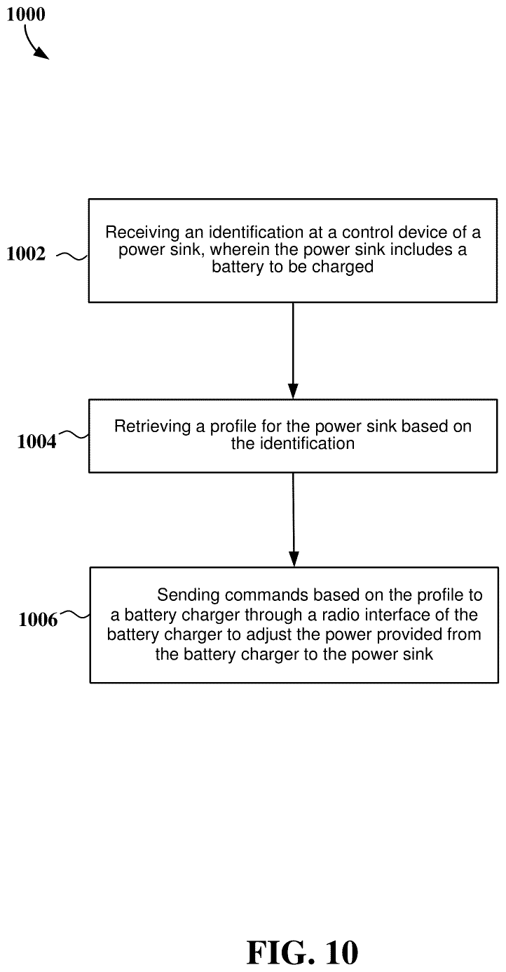

FIG. 10 is a process flow diagram of controlling the charging of a power sink with a battery charger. At 1002, an identification is received at a control device of a power sink, wherein the power sink includes a battery to be charged. In examples, the profile is received through a Bluetooth radio from the battery charger or from the power sink. In examples, the profile is received through a GUI of the control device.

At 1004, a profile is retrieved for the power sink based on the identification. In examples, the profile is retrieved from a local memory of profiles. At 1006, commands are sent, based on the profile, to a battery charger through a radio interface of the battery charger to adjust the power provided from the battery charger to the power sink. In examples the radio interface includes a Bluetooth radio, The commands may include a voltage and a current to be provided to the power sink. The commands may include a profile identifier, where the profile defines a charging protocol for the power sink.

The process may further include retrieving a plurality of profiles for the power sink and selecting one of the plurality of profiles for the power sink. The commands may then be sent based on the selected profile. The profiles may include a slow charging protocol, a night charging protocol, a battery bleed prevention charging protocol and/or other suitable charging protocols.

The following provides an overview of examples of the present disclosure.

### Example 1

An apparatus comprising: a charging interface coupled to a power sink, the power sink comprising a battery to be charged; a supply interface coupled to a power supply configured to provide power to the charging interface; a radio interface coupled to a control device configured to receive one or more commands from the control device; and a controller coupled to the radio interface and configured to receive the commands from the radio interface, wherein the controller is further coupled to the charging interface and configured to adjust the power provided to the power sink in response to the commands.

### Example 2

The battery charger of example 1, wherein the charging interface comprises a wire interface.

### Example 3

The battery charger of example 2, wherein the wire interface is configured to receive an identification of the power sink from the power sink.

### Example 4

The battery charger of any one or more of examples 1-3, wherein the charging interface comprises an inductive coil.

### Example 5

The battery charger of any one or more of examples 1-4, wherein the one or more commands comprise a voltage and a current to be provided to the power sink.

### Example 6

The battery charger of any one or more of examples 1-5, wherein the radio interface is further coupled to the power sink and configured to receive an identification of the power sink through the radio interface.

### Example 7

The battery charger of any one or more of examples 1-6, wherein the charging interface is configured to receive an identification of the power sink from the power sink through the charging interface and wherein the radio interface is configured to send the identification to the control device.

### Example 8

The battery charger of any one or more of examples 1-7, wherein the one or more commands comprise a profile identifier of a charging profile, and wherein the charging profile defines a charging protocol for the power sink.

### Example 9

The battery charger of example 8, wherein the charging protocol comprises a voltage and a current.

### Example 10

The battery charger of any one or more of examples 1-9, further comprising a voltage regulator coupled between the supply interface and the charging interface and coupled to the controller, wherein the voltage regulator is configured to regulate a voltage provided to the power sink through the charging interface in response to the commands.

### Example 11

The battery charger of any one or more of examples 1-10, wherein the control device includes the power sink and a charging profile for the power sink, and wherein the commands from the control device include the charging profile.

### Example 12

A method comprising: receiving one or more commands at a battery charger from a control device through a radio interface; and adjusting a power provided to a power sink through a charging interface from a supply interface in response to the commands, wherein the power sink comprises a battery to be charged.

### Example 13

The method of example 12, wherein the receiving the one or more commands comprises receiving a profile identifier of a charging profile, and wherein the charging profile defines a charging protocol for the power sink.

### Example 14

The method of example 13, further comprising applying the profile identifier to a local memory of the battery charger to determine the charging profile for the power sink.

### Example 15

The method of any one or more of examples 12-14, wherein the adjusting the power comprises regulating a voltage provided to the power sink through the charging interface by a voltage regulator.

### Example 16

The method of any one or more of examples 12-15, further comprising: receiving an identification of a power sink, and sending the identification to the control device through the radio interface, wherein the receiving the one or more commands is in response to the sending the identification.

### Example 17

An apparatus comprising: means for receiving one or more commands at a battery charger from a control device through a radio interface; and means for adjusting a power provided to a power sink through a charging interface from a supply interface in response to the one or more commands, wherein the power sink comprises a battery to be charged.

### Example 18

The apparatus of example 17, wherein the means for receiving the one or more commands comprises means for receiving a profile identifier of a charging profile, and wherein the charging profile defines a charging protocol for the power sink.

### Example 19

The apparatus of example 18, further comprising means for applying the profile identifier to a local memory of the battery charger to determine the charging profile for the power sink.

### Example 20

The apparatus of example 18 or 19, wherein the charging protocol comprises a voltage and a current.

### Example 21

A method comprising: receiving an identification at a control device of a power sink, wherein the power sink comprises a battery to be charged; retrieving a profile for the power sink based on the identification; and sending commands based on the profile to a battery charger through a radio interface of the battery charger to adjust the power provided from the battery charger to the power sink.

### Example 22

The method of example 21, wherein the commands comprise a voltage and a current to be provided to the power sink.

### Example 23

The method of example 21 or 22, wherein the commands comprise a profile identifier of the profile, wherein the profile defines a charging protocol for the power sink.

### Example 24

The method of any one or more of examples 21-23 further comprising: retrieving a plurality of profiles for the power sink; and selecting one of the plurality of profiles for the power sink, wherein the sending the commands comprises sending a profile identifier of the selected profile.

### Example 25

The method of any one or more of examples 21-24, wherein the control device comprises the power sink and wherein receiving an identification comprises retrieving an identification from a register of the control device.

The processor 120, the controllers 142, 222 and other components discussed above may each be implemented with a controller or processor configured to perform the functions described herein by executing software including code for performing the functions. The software may be stored on a non-transitory computer-readable storage medium, e.g., a RAM, a ROM, an EEPROM, an optical disk, and/or a magnetic disk, such as local memory 122, 144, and 224, or as another memory.

Any reference to an element herein using a designation e.g., “first,” “second,” and so forth does not generally limit the quantity or order of those elements. Rather, these designations are used herein as a convenient way of distinguishing between two or more elements or instances of an element. Thus, a reference to first and second elements does not mean that only two elements can be employed, or that the first element must precede the second element.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect electrical or other communicative coupling between two structures. Also, the term “approximately” means within ten percent of the stated value.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A battery charger, comprising:
a charging interface coupled to a power sink, the power sink comprising a battery to be charged;
a supply interface coupled to a power supply configured to provide power to the charging interface;
a radio interface coupled to a control device configured to receive one or more commands from the control device; and
a controller coupled to the radio interface and configured to receive the commands from the radio interface,
wherein the controller is further coupled to the charging interface and configured to adjust the power provided to the power sink in response to the commands.

2. The battery charger of claim 1, wherein the charging interface comprises a wire interface.

3. The battery charger of claim 2, wherein the wire interface is configured to receive an identification of the power sink from the power sink.

4. The battery charger of claim 1, wherein the charging interface comprises an inductive coil.

5. The battery charger of claim 1, wherein the one or more commands comprise a voltage and a current to be provided to the power sink.

6. The battery charger of claim 1, wherein the radio interface is further coupled to the power sink and configured to receive an identification of the power sink through the radio interface.

7. The battery charger of claim 1, wherein the charging interface is configured to receive an identification of the power sink from the power sink through the charging interface and wherein the radio interface is configured to send the identification to the control device.

8. The battery charger of claim 1, wherein the one or more commands comprise a profile identifier of a charging profile, and wherein the charging profile defines a charging protocol for the power sink.

9. The battery charger of claim 8, wherein the charging protocol comprises a voltage and a current.

10. The battery charger of claim 1, further comprising a voltage regulator coupled between the supply interface and the charging interface and coupled to the controller, wherein the voltage regulator is configured to regulate a voltage provided to the power sink through the charging interface in response to the one or more commands.

11. The battery charger of claim 1, wherein the control device includes the power sink and a charging profile for the power sink, and wherein the one or more commands from the control device include the charging profile.

12. A method comprising:
receiving one or more commands at a battery charger from a control device through a radio interface; and
adjusting a power provided to a power sink through a charging interface from a supply interface in response to the one or more commands, wherein the power sink comprises a battery to be charged.

13. The method of claim 12, wherein the receiving the one or more commands comprises receiving a profile identifier of a charging profile, and wherein the charging profile defines a charging protocol for the power sink.

14. The method of claim 13, further comprising applying the profile identifier to a local memory of the battery charger to determine the charging profile for the power sink.

15. The method of claim 12, wherein the adjusting the power comprises regulating a voltage provided to the power sink through the charging interface by a voltage regulator.

16. The method of claim 12, further comprising:
receiving an identification of a power sink; and
sending the identification to the control device through the radio interface,
wherein the receiving the one or more commands is in response to the sending the identification.

17. An apparatus comprising:
means for receiving one or more commands at a battery charger from a control device through a radio interface; and
means for adjusting a power provided to a power sink through a charging interface from a supply interface in response to the one or more commands, wherein the power sink comprises a battery to be charged.

18. The apparatus of claim 17, wherein the means for receiving the one or more commands comprises means for receiving a profile identifier of a charging profile, and wherein the charging profile defines a charging protocol for the power sink.

19. The apparatus of claim 18, further comprising means for applying the profile identifier to a local memory of the battery charger to determine the charging profile for the power sink.

20. The apparatus of claim 18, wherein the charging protocol comprises a voltage and a current.
